(19) United States
(12) Patent Application Publication
(10) Pub. No.: US 2025/0328101 A1
(43) Pub. Date: Oct. 23, 2025

(54) IMAGE FORMING APPARATUS CAPABLE OF DETERMINING WHETHER OR NOT TO-BE-TRANSFERRED TONER IMAGE WILL STICK OUT FROM CONTACT AREA OF IMAGE-CARRYING MEMBER WITH SHEET, AND DETERMINATION METHOD

(71) Applicant: KYOCERA Document Solutions Inc., Osaka (JP)

(72) Inventors: Ayato Morikami, Osaka (JP); Makoto Matsumoto, Osaka (JP); Yasuaki Sakamoto, Osaka (JP); Masaru Watanabe, Osaka (JP); Yukiko Kotani, Osaka (JP)

(21) Appl. No.: 19/176,636

(22) Filed: Apr. 11, 2025

(30) Foreign Application Priority Data
Apr. 19, 2024 (JP) 2024-068141

(51) Int. Cl. G03G 15/00

(52) U.S. Cl. CPC G03G 15/5095; G03G 15/5058; G03G 2215/00059

(57) ABSTRACT

An image forming apparatus includes an image-carrying member, a transfer portion, a movement processing portion, and a determination processing portion. The image-carrying member conveys a toner image including a to-be-transferred toner image. The transfer portion transfers the to-be-transferred toner image onto a sheet that comes into contact with the image-carrying member. The movement processing portion causes a formation target image corresponding to the to-be-transferred toner image, that is included in image data used for forming the toner image, to move within the image data. The determination processing portion determines whether or not the to-be-transferred toner image that is based on the moved formation target image will stick out from a contact area of the image-carrying member that comes into contact with the sheet.

### INCORPORATION BY REFERENCE

This application is based upon and claims the benefit of priority from the corresponding Japanese Patent Application No. 2024-068141 filed on Apr. 19, 2024, the entire contents of which are incorporated herein by reference.

### BACKGROUND

The present disclosure relates to an image forming apparatus and a determination method.

An image forming apparatus that uses electrophotography includes an image-carrying member and a transfer portion. The image-carrying member conveys a toner image including a to-be-transferred toner image that is to be transferred onto a sheet. The transfer portion transfers the to-be-transferred toner image conveyed by the image-carrying member onto the sheet that comes into contact with the image-carrying member.

Further, there is known, as the related art, an image forming apparatus capable of moving a formation target image corresponding to the to-be-transferred toner image, that is included in image data used for forming the toner image, from a center portion of the image data in a main scanning direction toward an end portion side in the main scanning direction.

### SUMMARY

An image forming apparatus according to an aspect of the present disclosure includes an image-carrying member, a transfer portion, a movement processing portion, and a determination processing portion. The image-carrying member conveys a toner image including a to-be-transferred toner image to be transferred onto a sheet. The transfer portion transfers the to-be-transferred toner image conveyed by the image-carrying member onto the sheet that comes into contact with the image-carrying member. The movement processing portion causes a formation target image corresponding to the to-be-transferred toner image, that is included in image data used for forming the toner image, to move within the image data. The determination processing portion determines whether or not the to-be-transferred toner image that is based on the formation target image that has been moved by the movement processing portion will stick out from a contact area of the image-carrying member that comes into contact with the sheet.

A determination method according to another aspect of the present disclosure is executed in an image forming apparatus including an image-carrying member which conveys a toner image including a to-be-transferred toner image to be transferred onto a sheet, and a transfer portion which transfers the to-be-transferred toner image conveyed by the image-carrying member onto the sheet that comes into contact with the image-carrying member, and includes a movement step and a determination step. The movement step includes causing a formation target image corresponding to the to-be-transferred toner image, that is included in image data used for forming the toner image, to move within the image data. The determination step includes determining whether or not the to-be-transferred toner image that is based on the formation target image that has been moved in the movement step will stick out from a contact area of the image-carrying member that comes into contact with the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus according to an embodiment of the present disclosure;

FIG. 2 is a block diagram showing a system configuration of the image forming apparatus according to the embodiment of the present disclosure;

FIG. 3 is a cross-sectional view showing a configuration of an image forming portion of the image forming apparatus according to the embodiment of the present disclosure;

FIG. 4 is a bottom view showing a configuration of an intermediate transfer belt of the image forming apparatus according to the embodiment of the present disclosure;

FIG. 5 is a flowchart showing an example of print data output processing executed in the image forming apparatus according to the embodiment of the present disclosure;

FIG. 6 is a diagram showing an example of print data generated by the image forming apparatus according to the embodiment of the present disclosure;

FIG. 7 is a diagram showing a state where a formation target image included in the print data shown in FIG. 6 is moved;

FIG. 8 is a diagram showing a state where a part of the formation target image included in the print data shown in FIG. 7 is cut off; and

FIG. 9 is a diagram showing a state where test images are added to the print data shown in FIG. 8.

### DETAILED DESCRIPTION

Hereinafter, an embodiment of the present disclosure will be described with reference to the attached drawings. It is noted that the following embodiment is an example of embodying the present disclosure and does not limit the technical scope of the present disclosure.

### [Configuration of Image Forming Apparatus 100]

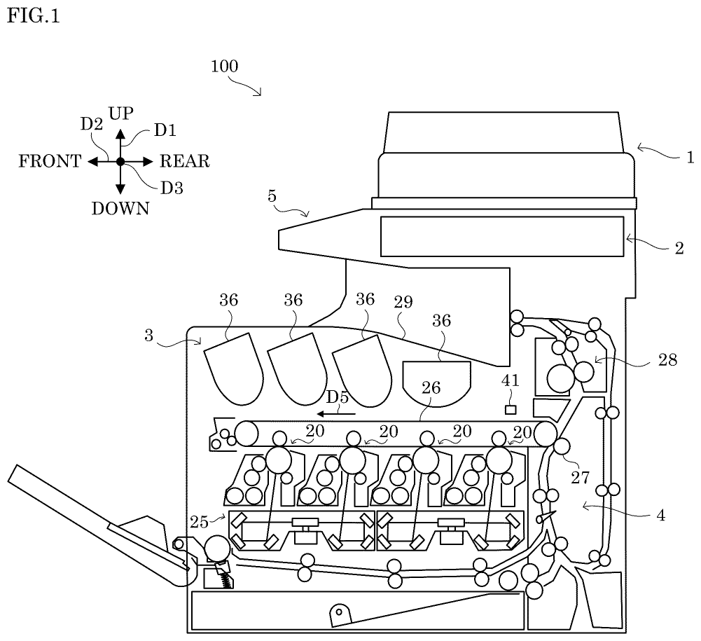

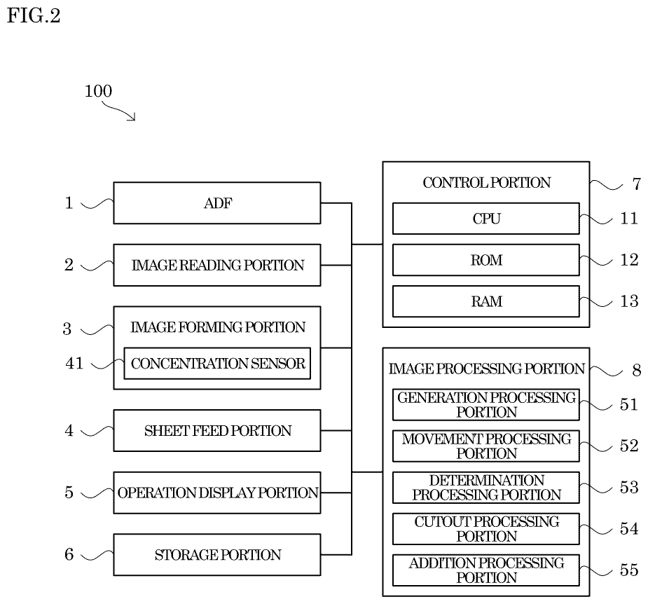

First, a configuration of an image forming apparatus 100 according to the embodiment of the present disclosure will be described with reference to FIG. 1 and FIG. 2.

It is noted that for convenience of descriptions, a vertical direction in a state where the image forming apparatus 100 is installed in a usable state (a state shown in FIG. 1) is defined as an up-down direction D1. In addition, a front-rear direction D2 is defined with a surface of the image forming apparatus 100 on a left side of a sheet surface shown in FIG. 1 being a front surface (front side). In addition, a left-right direction D3 is defined using the front surface of the image forming apparatus 100 in the installed state as a reference.

The image forming apparatus 100 is a multifunction peripheral having a plurality of functions such as a facsimile function and a copying function along with a scanning function for reading an image of a document sheet and a print function for forming an image based on image data. It is noted that the present disclosure may also be applied to image forming apparatuses such as a printer, a facsimile apparatus, and a copying machine that are capable of forming an image using electrophotography.

As shown in FIG. 1 and FIG. 2, the image forming apparatus 100 includes an ADF (Auto Document Feeder) 1, an image reading portion 2, an image forming portion 3, a sheet feed portion 4, an operation display portion 5, a storage portion 6, a control portion 7, and an image processing portion 8.

The ADF 1 conveys a document sheet as a reading target of the scanning function. The ADF 1 includes a document sheet setting portion, a plurality of conveying rollers, a document sheet holder, and a sheet discharge portion.

The image reading portion 2 realizes the scanning function. The image reading portion 2 includes a document sheet table, a light source, a plurality of mirrors, an optical lens, and a CCD (Charge Coupled Device).

The image forming portion 3 realizes the print function. Specifically, the image forming portion 3 forms a color or monochrome image on a sheet supplied from the sheet feed portion 4 using electrophotography.

The sheet feed portion 4 supplies sheets to the image forming portion 3. The sheet feed portion 4 includes a sheet feed cassette, a manual feed tray, and a plurality of conveying rollers.

The operation display portion 5 is a user interface of the image forming apparatus 100. The operation display portion 5 includes a display portion and an operation portion. The display portion displays various types of information in response to control instructions from the control portion 7. For example, the display portion is a flat panel display such as a liquid crystal display. The operation portion is used to input various types of information to the control portion 7 according to user operations. For example, the operation portion includes an operation key and a touch panel.

The storage portion 6 is a nonvolatile storage device. For example, the storage portion 6 is a nonvolatile memory such as a flash memory.

The control portion 7 collectively controls the image forming apparatus 100. As shown in FIG. 2, the control portion 7 includes a CPU 11, a ROM 12, and a RAM 13. The CPU 11 is a processor which executes various types of arithmetic processing. The ROM 12 is a nonvolatile storage device in which information such as control programs for causing the CPU 11 to execute various types of processing is stored in advance. The RAM 13 is a volatile or nonvolatile storage device that is used as a temporary storage memory (working area) for the various types of processing to be executed by the CPU 11. The CPU 11 executes the various control programs stored in advance in the ROM 12 to collectively control the image forming apparatus 100.

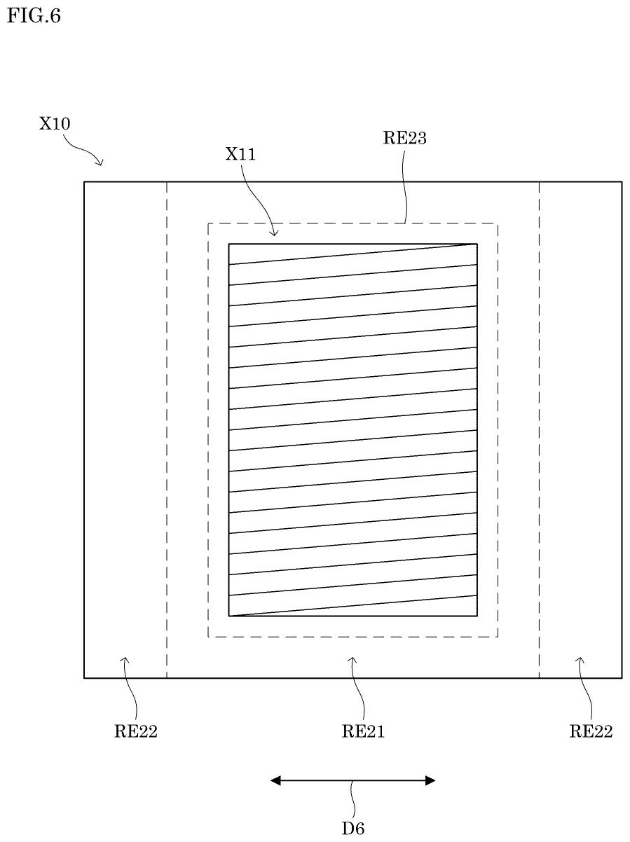

The image processing portion 8 generates print data X10 (see FIG. 6) that is used to form an image on a sheet. The print data X10 generated by the image processing portion 8 is input to the image forming portion 3. The image forming portion 3 forms an image on a sheet based on the print data X10 input from the image processing portion 8. For example, the image processing portion 8 is constituted of an electronic circuit such as an integrated circuit (ASIC, DSP).

### [Configuration of Image Forming Portion 3]

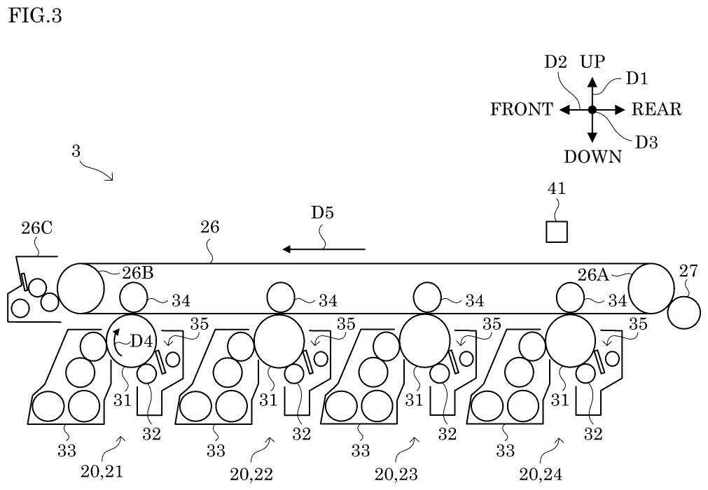

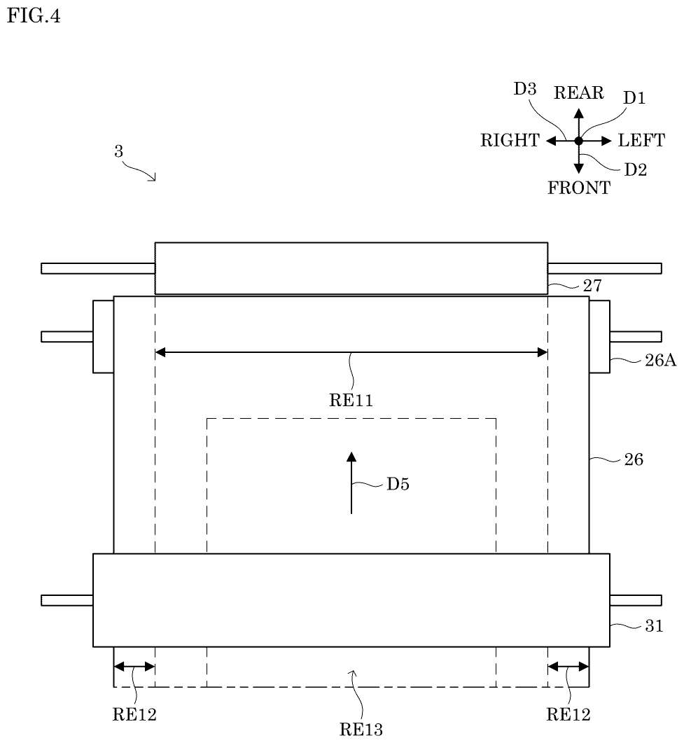

Next, a configuration of the image forming portion 3 will be described with reference to FIG. 1 to FIG. 4. Herein, FIG. 3 is a cross-sectional view showing configurations of a plurality of image forming units 20, an intermediate transfer belt 26, and a secondary transfer roller 27. Further, FIG. 4 is a bottom view showing configurations of a photoconductor drum 31 of the image forming unit 24, the intermediate transfer belt 26, a drive roller 26A, and the secondary transfer roller 27.

As shown in FIG. 1, the image forming portion 3 includes four image forming units 20, a laser scanning unit 25, the intermediate transfer belt 26, the secondary transfer roller 27, a fixing device 28, and a sheet discharge tray 29. In addition, as shown in FIG. 2, the image forming portion 3 includes a concentration sensor 41.

Of the four image forming units 20, the image forming unit 21 (see FIG. 3) forms a toner image of Y (yellow). The toner image includes a to-be-transferred toner image that is to be transferred onto a sheet. Further, the toner image may also include a test toner image that is used for adjusting image forming conditions. Of the four image forming units 20, the image forming unit 22 (see FIG. 3) forms the toner image of C (cyan). Of the four image forming units 20, the image forming unit 23 (see FIG. 3) forms the toner image of M (magenta). Of the four image forming units 20, the image forming unit 24 (see FIG. 3) forms the toner image of K (black). As shown in FIG. 1 and FIG. 3, the four image forming units 20 are arranged side by side in the order of yellow, cyan, magenta, and black along the front-rear direction D2 from the front side of the image forming apparatus 100.

As shown in FIG. 3, each of the image forming units 20 includes the photoconductor drum 31, a charging roller 32, a developing device 33, a primary transfer roller 34, and a drum cleaning portion 35. Each of the image forming units 20 also includes a toner container 36 shown in FIG. 1.

An electrostatic latent image is formed on a surface of the photoconductor drum 31. The photoconductor drum 31 rotates in a drum rotation direction D4 shown in FIG. 3 upon receiving a rotational driving force supplied from a motor (not shown). Thus, the photoconductor drum 31 conveys the electrostatic latent image formed on the surface thereof.

Upon receiving an application of a preset charging voltage, the charging roller 32 charges the surface of the photoconductor drum 31. The surface of the photoconductor drum 31 charged by the charging roller 32 is irradiated with light that is emitted from the laser scanning unit 25 and is based on the print data X10. Thus, the electrostatic latent image is formed on the surface of the photoconductor drum 31.

The developing device 33 develops the electrostatic latent image formed on the surface of the photoconductor drum 31. The developing device 33 includes a pair of stirring members, a magnet roller, and a developing roller. The pair of stirring members stir the developer containing the toner and a carrier, that is stored inside the developing device 33. The magnet roller draws the developer stirred by the pair of stirring members and supplies the toner contained in the developer to the developing roller. The developing roller conveys the toner supplied from the magnet roller to an opposing position that opposes the photoconductor drum 31. In addition, upon receiving an application of a preset development bias voltage, the developing roller supplies the toner conveyed to the opposing position to the photoconductor drum 31. Thus, the toner is selectively supplied to an exposure area of the photoconductor drum 31 that has been irradiated with the light emitted from the laser scanning unit 25, and the electrostatic latent image formed on the surface of the photoconductor drum 31 is developed. It is noted that the toner from the toner container 36 is supplied to the developing device 33.

By being supplied with a preset primary transfer current, the primary transfer roller 34 transfers the toner image formed on the surface of the photoconductor drum 31 onto an outer circumferential surface of the intermediate transfer belt 26. As shown in FIG. 3, the primary transfer roller 34 is provided so as to oppose the photoconductor drum 31 with the intermediate transfer belt 26 interposed therebetween.

The drum cleaning portion 35 removes the toner remaining on the surface of the photoconductor drum 31 after the toner image has been transferred by the primary transfer roller 34.

The laser scanning unit 25 emits light that is based on the print data X10 toward the surface of the photoconductor drum 31 of each of the image forming units 20.

The intermediate transfer belt 26 is an endless belt member onto which the toner image formed on the surface of the photoconductor drum 31 of each of the image forming units 20 is transferred. The intermediate transfer belt 26 is stretched with a predetermined tension by the drive roller 26A (see FIG. 3) and a tension roller 26B (see FIG. 3). The intermediate transfer belt 26 rotates in a belt rotation direction D5 shown in FIG. 3 by the drive roller 26A rotating upon receiving a rotational driving force supplied from a motor (not shown). Thus, the intermediate transfer belt 26 conveys the toner image transferred from each of the photoconductor drums 31 to a transfer position for transfer onto a sheet by the secondary transfer roller 27. The intermediate transfer belt 26 is an example of an image-carrying member according to the present disclosure. It is noted that the outer circumferential surface of the intermediate transfer belt 26 after the to-be-transferred toner image included in the toner image is transferred by the secondary transfer roller 27 is cleaned by a belt cleaning portion 26C (see FIG. 3).

Upon being supplied with a preset secondary transfer current, the secondary transfer roller 27 transfers the to-be-transferred toner image out of the toner image conveyed by the intermediate transfer belt 26 onto a sheet that comes into contact with the intermediate transfer belt 26. As shown in FIG. 3, the secondary transfer roller 27 is provided so as to oppose the drive roller 26A with the intermediate transfer belt 26 interposed therebetween. The secondary transfer roller 27 is biased toward the drive roller 26A by a bias member (not shown). Thus, a transfer nip portion for nipping a sheet is formed between the secondary transfer roller 27 and the intermediate transfer belt 26. The to-be-transferred toner image conveyed by the intermediate transfer belt 26 is transferred onto the sheet that comes into contact with the intermediate transfer belt 26 at the transfer nip portion. The secondary transfer roller 27 is an example of a transfer portion according to the present disclosure.

As shown in FIG. 4, a size of the secondary transfer roller 27 in an axial direction (left-right direction D3) is smaller than a width of the intermediate transfer belt 26 (a size in the left-right direction D3). Therefore, non-contact areas RE12 (see FIG. 4) that do not come into contact with the secondary transfer roller 27 are generated on the outer circumferential surface of the intermediate transfer belt 26. The non-contact areas RE12 are each an area outside a roller contact area RE11 (see FIG. 4) that comes into contact with the secondary transfer roller 27 on the outer circumferential surface of the intermediate transfer belt 26, and each include an end portion of the intermediate transfer belt 26 in a width direction. The to-be-transferred toner image is transferred in the roller contact area RE11. Further, the test toner images are transferred in the non-contact areas RE12.

The fixing device 28 fixes the to-be-transferred toner image that has been transferred onto the sheet by the secondary transfer roller 27 onto the sheet.

The sheet on which the to-be-transferred toner image has been fixed by the fixing device 28 is discharged onto the sheet discharge tray 29.

The concentration sensor 41 is provided in correspondence with each of the non-contact areas RE12 (see FIG. 4) on the outer circumferential surface of the intermediate transfer belt 26. The concentration sensor 41 senses a concentration of the test toner image that has been transferred in the non-contact area RE12 of the intermediate transfer belt 26. For example, the concentration sensor 41 is a reflective photosensor including a light-emitting portion that emits light toward the non-contact area RE12 of the intermediate transfer belt 26 and a light-receiving portion that receives the light that is emitted from the light-emitting portion and reflected by the non-contact area RE12 of the intermediate transfer belt 26. As shown in FIG. 3, the concentration sensor 41 is arranged at a position more on a downstream side of the belt rotation direction D5 than the transfer position (the transfer nip portion) of the to-be-transferred toner image by the secondary transfer roller 27 and more on an upstream side of the belt rotation direction D5 than a cleaning position of the outer circumferential surface of the intermediate transfer belt 26 by the belt cleaning portion 26C. The concentration sensor 41 inputs an electric signal corresponding to the concentration of the test toner image to the control portion 7. The control portion 7 adjusts the image forming conditions such as the development bias voltage and an amount of light to be emitted from the laser scanning unit 25, based on the sensing result on the concentration of the test toner image obtained by the concentration sensor 41.

### [Configuration of Image Processing Portion 8]

Next, a configuration of the image processing portion 8 will be described with reference to FIG. 2.

As shown in FIG. 2, the image processing portion 8 includes a generation processing portion 51, a movement processing portion 52, a determination processing portion 53, a cutout processing portion 54, and an addition processing portion 55. It is noted that the CPU 11 of the control portion 7 may execute the control programs stored in the ROM 12 to function as the respective processing portions described above.

The generation processing portion 51 generates the print data X10 (an example of image data according to the present disclosure) that is used to form the toner image.

FIG. 6 shows an example of the print data X10 generated by the generation processing portion 51. It is noted that in FIG. 6, boundaries among a first area RE21, a pair of second areas RE22, and a third area RE23 are indicated by broken lines. Also in FIG. 6, a formation target image X11 is hatched.

As shown in FIG. 6, the print data X10 includes the first area RE21, the pair of second areas RE22, and the third area RE23. The first area RE21 corresponds to the roller contact area RE11 (see FIG. 4) of the intermediate transfer belt 26. Each of the second areas RE22 corresponds to the non-contact area RE12 (see FIG. 4) of the intermediate transfer belt 26. The third area RE23 corresponds to a sheet contact area RE13 (see FIG. 4) of the intermediate transfer belt 26 that comes into contact with the sheet. The third area RE23 is set based on a size of the sheet used for printing. In addition, the third area RE23 is set at a center of the print data X10 in a main scanning direction D6 (see FIG. 6). The main scanning direction D6 is a direction corresponding to the width direction (left-right direction D3) of the intermediate transfer belt 26.

Furthermore, as shown in FIG. 6, the print data X10 includes the formation target image X11 corresponding to the to-be-transferred toner image. The formation target image X11 is arranged at a center of the sheet contact area RE13.

An area outside the formation target image X11 in the print data X10 is constituted of colorless pixels. The colorless pixels are pixels that are not developed by toner.

For example, when print processing for forming an image on a sheet is executed, the control portion 7 inputs image data including a formation target image X11 to be printed to the image processing portion 8. When the image data including the formation target image X11 is input from the control portion 7, the generation processing portion 51 generates the print data X10 based on the formation target image X11 included in the image data. It is noted that when the formation target image X11 includes a margin area, the generation processing portion 51 may generate the print data X10 based on the formation target image X11 from which the margin area has been cut off.

The movement processing portion 52 causes the formation target image X11 corresponding to the to-be-transferred toner image, that is included in the print data X10 used for forming the toner image, to move within the print data X10.

Specifically, the movement processing portion 52 causes the formation target image X11 to move along the main scanning direction D6.

Further, the movement processing portion 52 causes the formation target image X11 to move based on a movement amount that has been preset by a user operation made on the operation display portion 5.

Incidentally, when the formation target image X11 is moved toward an end portion side of the print data X10 in the main scanning direction D6, the to-be-transferred toner image that is based on the moved formation target image X11 may stick out from the sheet contact area RE13 (see FIG. 4) of the intermediate transfer belt 26 that comes into contact with the sheet.

However, conventionally, there has been no configuration capable of determining whether or not the to-be-transferred toner image that is based on the moved formation target image X11 will stick out from the sheet contact area RE13 on the intermediate transfer belt 26.

In contrast, in the image forming apparatus 100 according to the embodiment of the present disclosure, it is possible to determine whether or not the to-be-transferred toner image will stick out from the sheet contact area RE13 on the intermediate transfer belt 26 as will be described below.

The determination processing portion 53 determines whether or not the to-be-transferred toner image that is based on the formation target image X11 that has been moved by the movement processing portion 52 will stick out from the sheet contact area RE13 (an example of a contact area according to the present disclosure) of the intermediate transfer belt 26 that comes into contact with the sheet.

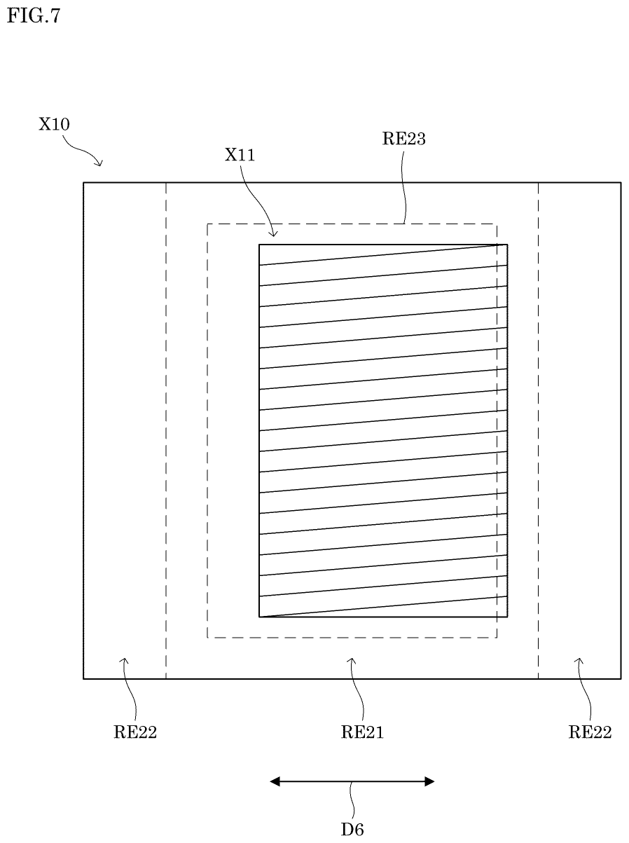

Specifically, when the formation target image X11 that has been moved by the movement processing portion 52 sticks out from the third area RE23 (see FIG. 7), the determination processing portion 53 determines that the to-be-transferred toner image that is based on the formation target image X11 that has been moved by the movement processing portion 52 will stick out from the sheet contact area RE13 on the intermediate transfer belt 26.

When the determination processing portion 53 determines that the to-be-transferred toner image will stick out from the sheet contact area RE13, the cutout processing portion 54 cuts out a partial image of the formation target image X11 that corresponds to a stick-out portion of the to-be-transferred toner image that sticks out from the sheet contact area RE13.

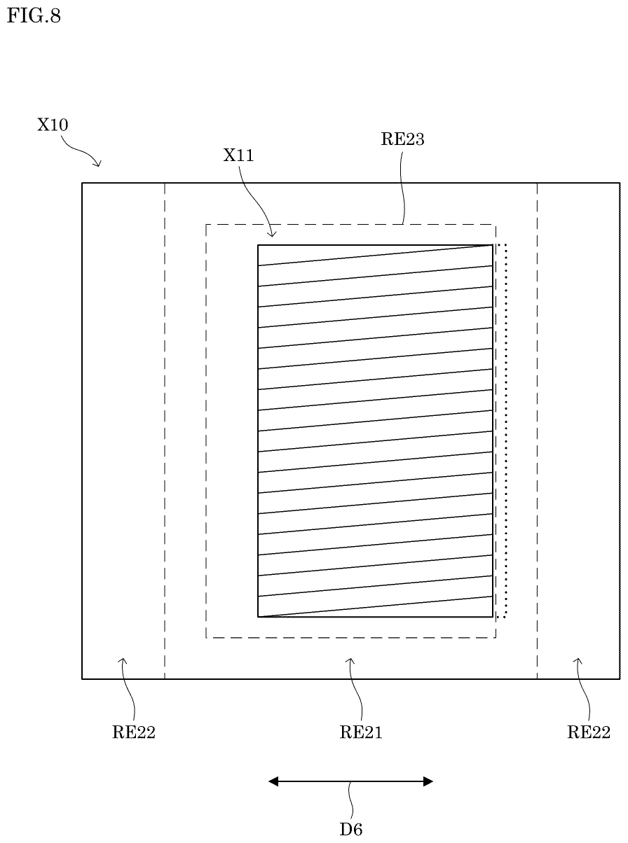

Specifically, the cutout processing portion 54 specifies a portion of the formation target image X11 that sticks out from the third area RE23 as the partial image, and cuts out the specified partial image. More specifically, the cutout processing portion 54 replaces pixels that constitute the specified partial image with the colorless pixels. It is noted that in FIG. 8, the cut-out partial image is indicated by a dotted line.

The addition processing portion 55 adds test images X12 corresponding to the test toner images in the second areas RE22 in the print data X10 generated by the generation processing portion 51.

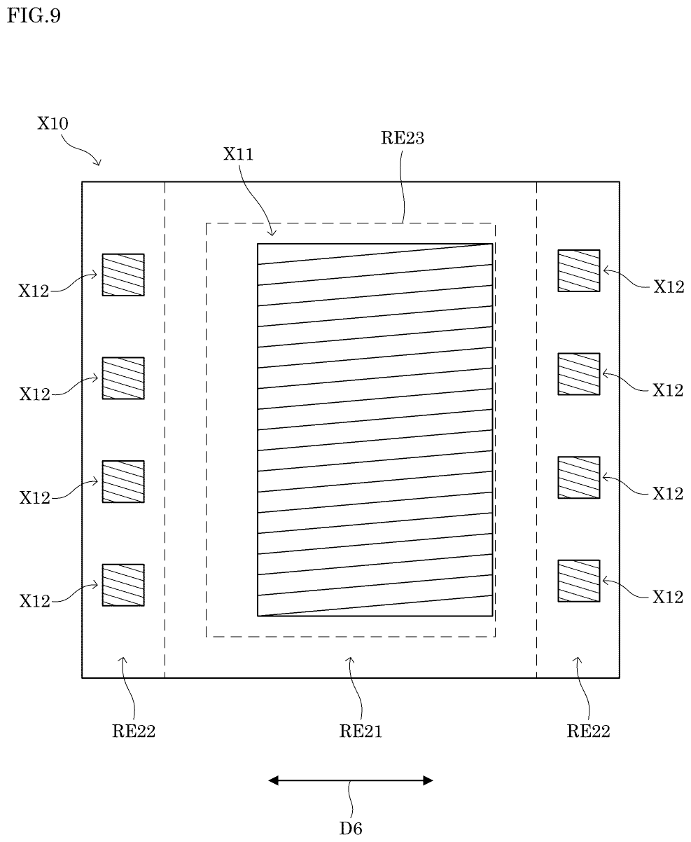

For example, the test image X12 is a monochrome rectangular image (see FIG. 9). It is noted that the test images X12 are hatched in FIG. 9.

For example, the addition processing portion 55 adds the test images X12 to each of the second areas RE22 (see FIG. 9).

### [Print Data Output Processing]

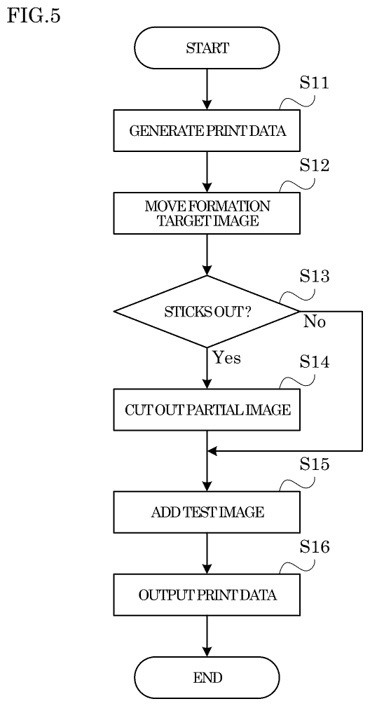

Hereinafter, with reference to FIG. 5, a determination method according to the present disclosure will be described along with exemplary procedures of print data output processing executed by the image processing portion 8 in the image forming apparatus 100. Herein, Step S11, Step S12, . . . represent numbers of processing procedures (steps) executed by the image processing portion 8. It is noted that the image processing portion 8 executes the print data output processing when image data including the formation target image X11 is input from the control portion 7.

### <Step S11>

First, in Step S11, the image processing portion 8 generates print data X10. The processing of Step S11 is executed by the generation processing portion 51 of the image processing portion 8.

Specifically, the image processing portion 8 generates the print data X10 (see FIG. 6) based on the formation target image X11 included in the image data input from the control portion 7.

### <Step S12>

In Step S12, the image processing portion 8 causes the formation target image X11 to move along the main scanning direction D6 based on the movement amount that has been preset by a user operation made on the operation display portion 5. The processing of Step S12 is an example of a movement step according to the present disclosure and is executed by the movement processing portion 52 of the image processing portion 8.

### <Step S13>

In Step S13, the image processing portion 8 determines whether or not the to-be-transferred toner image that is based on the formation target image X11 that has been moved by the processing of Step S12 will stick out from the sheet contact area RE13 on the intermediate transfer belt 26. The processing of Step S13 is an example of a determination step according to the present disclosure and is executed by the determination processing portion 53 of the image processing portion 8.

Specifically, when the formation target image X11 that has been moved by the processing of Step S12 is sticking out from the third area RE23 (see FIG. 7), the image processing portion 8 determines that the to-be-transferred toner image that is based on the moved formation target image X11 will stick out from the sheet contact area RE13.

Herein, when determining that the to-be-transferred toner image that is based on the moved formation target image X11 will stick out from the sheet contact area RE13 (Yes in S13), the image processing portion 8 shifts the processing to Step S14. On the other hand, when determining that the to-be-transferred toner image that is based on the moved formation target image X11 will not stick out from the sheet contact area RE13 (No in S13), the image processing portion 8 shifts the processing to Step S15.

### <Step S14>

In Step S14, the image processing portion 8 cuts out the partial image of the formation target image X11 that corresponds to the stick-out portion of the to-be-transferred toner image that sticks out from the sheet contact area RE13. The processing of Step S14 is executed by the cutout processing portion 54 of the image processing portion 8.

It is noted that instead of the processing of Step S14, the image processing portion 8 may execute processing of causing the formation target image X11 to move in a direction opposite to the movement direction in the processing of Step S12 so that the formation target image X11 fits inside the third area RE23.

Alternatively, instead of the processing of Step S14, the image processing portion 8 may execute processing of notifying the control portion 7 that the to-be-transferred toner image that is based on the moved formation target image X11 will stick out from the sheet contact area RE13. In this case, the control portion 7 only needs to stop the print processing and notify the user that the to-be-transferred toner image that is based on the moved formation target image X11 will stick out from the sheet contact area RE13 when receiving the notification from the image processing portion 8.

### <Step S15>

In Step S15, the image processing portion 8 adds the test images X12 (see FIG. 9) to the second areas RE22 in the print data X10 generated by the processing of Step S11. The processing of Step S15 is executed by the addition processing portion 55 of the image processing portion 8.

### <Step S16>

In Step S16, the image processing portion 8 outputs the print data X10 to which the test images X12 have been added.

Specifically, the image processing portion 8 breaks down the print data X10 into color component data respectively corresponding to the colors of YCMK, and outputs the four pieces of color component data.

The print data X10 output by the processing of Step S16 is input to the image forming portion 3. In the image forming portion 3, the toner image including the to-be-transferred toner image and the test toner images is formed based on the input print data X10.

In this manner, the image forming apparatus 100 can determine, based on the print data X10 including the formation target image X11 that has been moved by the movement processing portion 52, whether or not the to-be-transferred toner image that is based on the moved formation target image X11 will stick out from the sheet contact area RE13 on the intermediate transfer belt 26.

It is noted that the movement processing portion 52 may alternatively cause the formation target image X11 to move along a sub-scanning direction orthogonal to the main scanning direction D6.

### [Notes of Disclosure]

Hereinafter, a general outline of the disclosure extracted from the embodiment described above will be noted. It is noted that the respective configurations and processing functions described in the notes below can be sorted and arbitrarily combined as appropriate.

### <Note 1>

An image forming apparatus, including: an image-carrying member which conveys a toner image including a to-be-transferred toner image to be transferred onto a sheet; a transfer portion which transfers the to-be-transferred toner image conveyed by the image-carrying member onto the sheet that comes into contact with the image-carrying member; a movement processing portion which causes a formation target image corresponding to the to-be-transferred toner image, that is included in image data used for forming the toner image, to move within the image data; and a determination processing portion which determines whether or not the to-be-transferred toner image that is based on the formation target image that has been moved by the movement processing portion will stick out from a contact area of the image-carrying member that comes into contact with the sheet.

### <Note 2>

The image forming apparatus according to note 1, including: a cutout processing portion which cuts out, when determined by the determination processing portion that the to-be-transferred toner image will stick out from the contact area, a partial image of the formation target image that corresponds to a stick-out portion of the to-be-transferred toner image that sticks out from the contact area.

### <Note 3>

A determination method executed in an image forming apparatus including an image-carrying member which conveys a toner image including a to-be-transferred toner image to be transferred onto a sheet, and a transfer portion which transfers the to-be-transferred toner image conveyed by the image-carrying member onto the sheet that comes into contact with the image-carrying member, the determination method including: a movement step of causing a formation target image corresponding to the to-be-transferred toner image, that is included in image data used for forming the toner image, to move within the image data; and a determination step of determining whether or not the to-be-transferred toner image that is based on the formation target image that has been moved in the movement step will stick out from a contact area of the image-carrying member that comes into contact with the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
an image-carrying member which conveys a toner image including a to-be-transferred toner image to be transferred onto a sheet;
a transfer portion which transfers the to-be-transferred toner image conveyed by the image-carrying member onto the sheet that comes into contact with the image-carrying member;
a movement processing portion which causes a formation target image corresponding to the to-be-transferred toner image, that is included in image data used for forming the toner image, to move within the image data; and
a determination processing portion which determines whether or not the to-be-transferred toner image that is based on the formation target image that has been moved by the movement processing portion will stick out from a contact area of the image-carrying member that comes into contact with the sheet.

2. The image forming apparatus according to claim 1, comprising:
a cutout processing portion which cuts out, when determined by the determination processing portion that the to-be-transferred toner image will stick out from the contact area, a partial image of the formation target image that corresponds to a stick-out portion of the to-be-transferred toner image that sticks out from the contact area.

3. A determination method executed in an image forming apparatus including an image-carrying member which conveys a toner image including a to-be-transferred toner image to be transferred onto a sheet, and a transfer portion which transfers the to-be-transferred toner image conveyed by the image-carrying member onto the sheet that comes into contact with the image-carrying member, the determination method comprising:
a movement step of causing a formation target image corresponding to the to-be-transferred toner image, that is included in image data used for forming the toner image, to move within the image data; and
a determination step of determining whether or not the to-be-transferred toner image that is based on the formation target image that has been moved in the movement step will stick out from a contact area of the image-carrying member that comes into contact with the sheet.
